(19) United States
(12) Patent Application Publication
(10) Pub. No.: US 2009/0025043 A1
(43) Pub. Date: Jan. 22, 2009

(54) Multiband receiving apparatus and multiband transmitting apparatus using tunable filter

(75) Inventors: In-sang Song, Seoul (KR); Duck-hwan Kim, Goyang-si (KR); Chul-soo Kim, Hwaseong-si (KR); Yun-kwon Park, Dongducheon-si (KR); Jung-eun Lee, Yongin-si (KR); Jea-shik Shin, Suwon-si (KR)

Correspondence Address: MCNEELY BODENDORF LLP, P.O. BOX 34175, WASHINGTON, DC, 20043, US

(73) Assignee: Samsung Electro-Mechanics Co., Ltd.

(21) Appl. No.: 11/979,681

(22) Filed: Nov. 7, 2007

(30) Foreign Application Priority Data
Jul. 20, 2007 (KR) 2007-72907

(51) Int. Cl. H04N 5/14

(52) U.S. Cl. 725/85

(57) ABSTRACT

A multiband receiving apparatus and multiband transmitting apparatus using a tunable band is provided. The receiving apparatus includes a receiving unit for receiving radio frequency (RF) signals, and a tunable filter unit for selectively outputting the received RF signals. As a result, a complicated RF transceiving system is simplified, and time and cost for developing and designing a transceiving apparatus are reduced.

### CROSS-REFERENCE TO RELATED APPLICATIONS

This application claims the benefit under 35 U.S.C. § 119 of Korean Patent Application No. 2007-072907, filed on Jul. 20, 2007, in the Korean Intellectual Property Office (KIPO), the entire disclosure of which is hereby incorporated by reference.

### BACKGROUND OF THE INVENTION

1. Field of the Invention

The present invention relates to a multiband receiving apparatus and a multiband transmitting apparatus, and more particularly, to a multiband receiving apparatus and a multiband transmitting apparatus for receiving radio frequency (RF) signal from a plurality of frequency bands and extracting signal from a desired band.

2. Description of the Related Art

FIG. 1 is a block diagram of a conventional radio frequency (RF) device receiving an RF signal.

The RF device of FIG. 1 includes a transceiving unit 10, a switch duplexer 20, a low noise amplifier (LNA) 30-1, a power amplifier (PA) 30-2, a reception (RX) filter 40-1, a transmission (TX) filter 40-2, a down mixer 50-1, an up mixer 50-2, amplifiers 50-1, 50-2, filters 70-1, 70-2, an analog-to-digital converter (ADC) 60-1, a digital-to-analog converter (DAC), and a crystal (X-tal) oscillator.

The transceiving unit 10 receives or transmits an RF signal. That is, the transceiving unit 10 receives an RF signal through the air and outputs the signal to the switch duplexer 20. In reverse, the transceiving unit 10 receives a signal from the switch duplexer 20 and outputs it externally.

The switch duplexer 20 operates to connect antennas at transmitting and receiving ends. Specifically, the switch duplexer 20 uses a single antenna, but divides the receiving end from the transmitting end. The switch duplexer 20 outputs a signal received by the transceiving unit 10 to the LNA 30-1.

The LNA 30-1 operates to receive and amplify an RF signal. The LNA 120 outputs the amplified RF signal to the RX filter 40-1.

The RX filter 40-1 filters the amplified RF signal to remove external noise, and outputs the resultant signal to the down mixer 50-1.

The down mixer 50-1 receives a signal from the RX filter 40-1 and converges the received signal to a baseband signal. Specifically, the down mixer 50-1 converts the signal frequency output from the RX filter 40-1 to a baseband frequency to facilitate signal processing.

The amplifier 60-1 receives and amplifies the baseband signal, and outputs the amplified signal to the filter 70-1.

The filter 70-1 is provided to remove unnecessary frequency areas from the baseband signal. Specifically, the filter 70-1 leaves only the frequency domain signal by passing the amplified baseband signal through low band filtering.

As the frequency domain signal is obtained, the signal is output to the ADC 80-1, where the signal is converted from analog to digital form.

The X-tal oscillator 90 operates to supply an oscillation signal at a predetermined frequency.

In the process of transmitting an RF signal, the DAC 80-2 converts a received signal to analog form if a digital signal is received, and outputs the analog signal to the filter 70-2.

The filter 60-2 receives and filters the analog signal, and outputs it to the amplifier 60-2.

The amplifier 60-2 amplifies the signal filtered by the filter 60-2 and outputs the resultant signal to the up mixer 50-2.

The up mixer 50-2 converts the baseband analog signal to an RF signal and outputs the resultant signal to the PA 30-2.

The PA 30-2 operates to amplify the received RF signal robustly at the end of the transmitting end, so that the amplified signal is input to the switch duplexer 20.

The signal input to the switch duplexer 20 is sent out through the transceiving unit 10.

As explained above, the conventional system requires many mixers 50-1, 50-2 and filters to select a desired signal of a frequency domain. The presence of many components including mixers and filters causes the transceiving system to be complicated and bulky, and results in increased costs.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus for receiving or transmitting a multiband signal using a tunable filter.

The above objects of the present invention are substantially realized by providing a multiband receiving apparatus, including a receiving unit for receiving radio frequency (RF) signals from a plurality of frequency bands, wherein each of the frequency band comprises a plurality of frequency channels, and a tunable filter unit for filtering the RF signals received through the receiving unit according to the channel, and selecting and outputting an RF signal filtered at a predetermined channel.

The tunable filter unit may include a plurality of tunable filters provided for each of the frequency bands, and a band selecting unit for selecting a predetermined frequency band from the plurality of frequency bands, and outputting the filtered RF signal.

The tunable filters may each filter an RF signal received through the receiving unit from each of the frequency bands, and select and output the filtered RF signal of a predetermined channel.

The tunable filter unit may include channel filters provided for each of the plurality of frequency channels, and a channel selecting unit for selecting a predetermined frequency channel so that an RF signal being filtered by the channel filter of the predetermined frequency band is output.

The above objects of the present invention are substantially realized by providing a multiband transmitting apparatus, including a tunable filter unit for filtering radio frequency (RF) signals of a plurality of frequency bands according to the channel, and selecting and outputting an RF signal filtered at a predetermined channel, wherein the frequency bands each comprise a plurality of frequency channels, and a transmitting unit for transmitting the signal output from the tunable filter unit.

The tunable filter unit may include a plurality of tunable filters provided for each of the frequency bands, and a band selecting unit for selecting a predetermined frequency band from the plurality of frequency bands, and outputting the filtered RF signal.

The tunable filters may each filter an RF signal received through the receiving unit from each of the frequency bands, and select and output the filtered RF signal of a predetermined channel.

The tunable filter unit may include channel filters provided for each of the plurality of frequency channels, and a channel selecting unit for selecting a predetermined frequency channel so that an RF signal being filtered by the channel filter of the predetermined frequency band is output.

Other objects, advantages and salient features of the invention will become apparent to those skilled in the art from the following detailed description, which, taken in conjunction with the annexed drawings discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram of a conventional radio frequency (RF) transceiving apparatus;

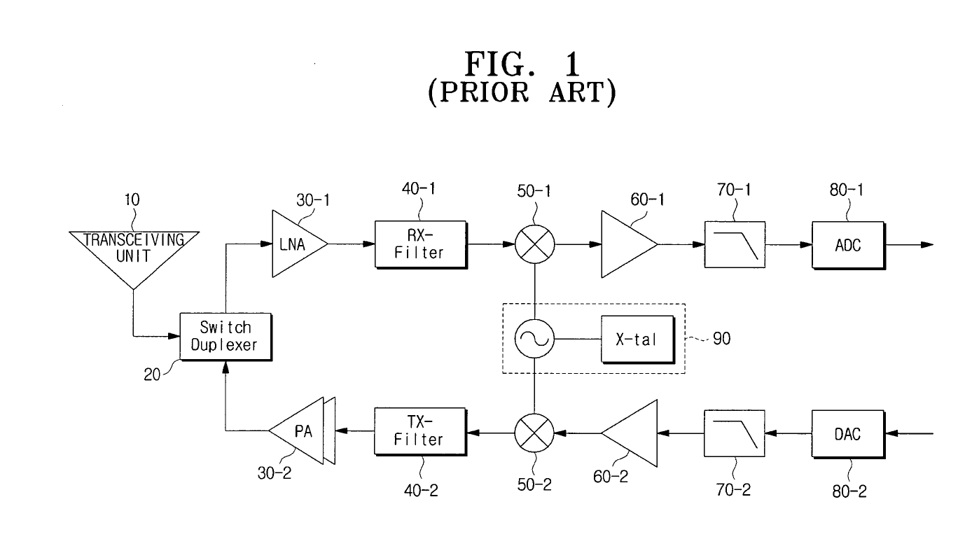

FIG. 2 is a block diagram of a transceiving apparatus according to an exemplary embodiment of the present invention;

FIG. 3 is a block diagram of a transceiving apparatus according to another exemplary embodiment of the present invention; and

FIG. 4 is a block diagram of a transceiving apparatus according to yet another exemplary embodiment of the present invention.

Throughout the drawings, the same drawing reference numerals will be understood to refer to the same elements, features and structures.

### DETAILED DESCRIPTION OF THE PREFERRED EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

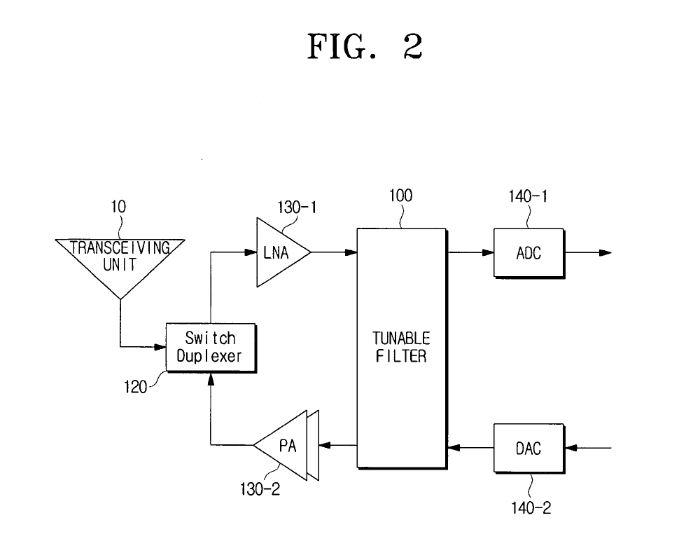

FIG. 2 is a block diagram of a transceiving apparatus according to an exemplary embodiment of the present invention.

Referring to FIG. 2, the transceiving apparatus according to an exemplary embodiment of the present invention may include a transceiving unit 110, a switch duplexer 120, a low noise amplifier (LNA) 130-1, a power amplifier (PA) 130-2, a tunable filter 100, an analog-to-digital converter (ADC) 60-1, and a digital-to-analog converter (DAC).

The process of receiving an RF signal through the transceiving unit 110, filtering the received signal and converting it from analog to digital form will be explained in greater detail below.

The transceiving unit 110 receives or sends out an RF signal through the air. Specifically, the transceiving unit 110 receives an electromagnetic wave signal from the air, and transmits the received signal to the switch duplexer 120 using electric conversion through the line, and sends out a signal received by the switch duplexer 120 to the air in an electromagnetic wave form also using the electric conversion through the line.

The switch duplexer 120, by connecting the transmitting and receiving ends with an antenna end, uses a single antenna but divides the transmitting end from the receiving end. The switch duplexer 120 outputs the received signal to the LNA 30-1.

The LNA 30-1 amplifies an RF signal, including a noise signal captured from the air. The LNA 120 is used because it is necessary to amplify the power level of the received signal, which is generally very low due to signal attenuation and noise influence, but to keep the noise included in the received signal at a minimum level. Because the LNA 120 is designed in consideration of operating point and matching point so as to reduce the noise factor (NF), the LNA 120 can meet the requirements for minimizing noise signals and amplifying the RF signal.

As a result, the LNA 120 amplifies a signal received by the transceiving unit 110 and outputs the amplified signal to the tunable filter 100.

The tunable filter 100 filters the received RF signal, and selectively outputs the filtered RF signal. Specifically, the tunable filter 100 filters the RF signals received from a plurality of frequency bands according to a channel, and selects and outputs an RF signal filtered through a predetermined channel. One frequency band may include a plurality of channels.

In receiving RF signals from a plurality of frequency bands and filtering the received signals, the tunable filter 100 filters the RF signals according to the channel, because each frequency band includes a plurality of frequency channels. The tunable filter 100 then selects an RF signal filtered at a predetermined channel, and outputs the selected RF signal to the ADC 140-1.

The ADC 140-1 converts the signal from the tunable filter 100 from analog to digital form for digital processing.

As explained above, the tunable filter 100 is used to selectively receive a signal that corresponds to a predetermined frequency channel of a predetermined frequency band.

The process of sending out a signal filtered by digital to analog conversion through the transceiving unit will be explained below.

The DAC 140-2 receives a digital signal, converts it into analog form, and transmits the converted signal to the tunable filer 100.

The tunable filter 100 receives and filters the analog signal, and selectively outputs a selected signal. In detail, the tunable filter 100 filters the signals received from a plurality of frequency bands according to the channel, and selects and outputs a signal filtered at a predetermined channel. Herein, one frequency band may include a plurality of channels.

In receiving RF signals from a plurality of frequency bands and filtering the received signals, the tunable filter 100 filters the RF signals according to the channel, because each frequency band includes a plurality of frequency channels. The tunable filter 100 then selects an RF signal filtered at a predetermined channel, and outputs the selected RF signal to the PA 130-2.

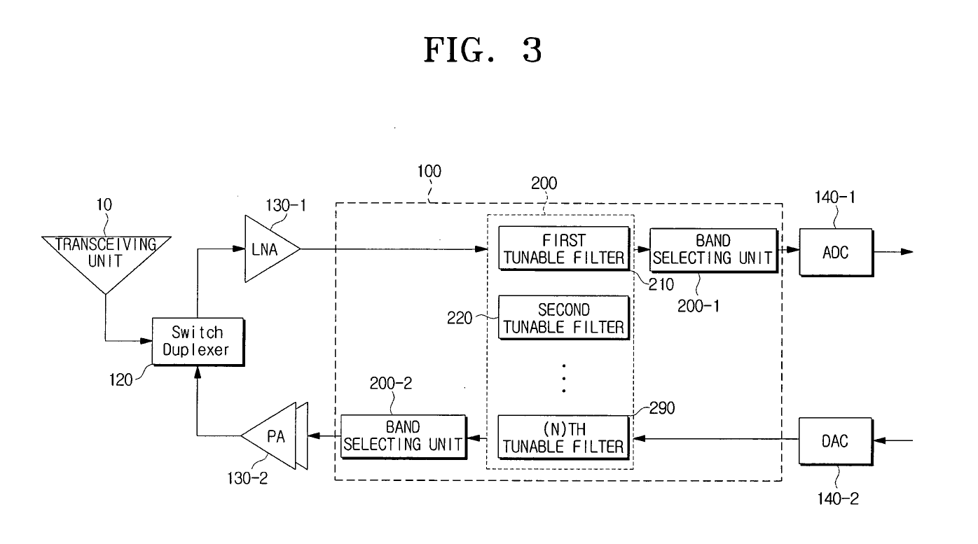

FIG. 3 is a block diagram of a transceiving apparatus according to another exemplary embodiment of the present invention.

Referring back to FIG. 3, the transceiving apparatus according to the second exemplary embodiment of the present invention may include a transceiving unit 110, a switch duplexer 120, a low noise amplifier (LNA) 130-1, a power amplifier (PA) 130-2, a tunable filter unit 100, an analog-to-digital converter (ADC) 60-1, and a digital-to-analog converter (DAC).

The process of receiving an RF signal will be explained in greater detail below, particularly with reference to the tunable filter unit 100, while other components, which have been explained above with reference to FIG. 2, will not be explained for the sake of brevity.

The tunable filter unit 100 includes a plurality of tunable filters 200 and band selectors 200-1, 200-2.

The tunable filters 200 may include a first tunable filter 210, a second tunable filter 220, . . . , and an (N)th tunable filter 290. The tunable filters 210, 220, . . . , 290 are classified according to frequency band, and each of the frequency bands includes a plurality of frequency channels.

Each of the tunable filters 200 filters an RF signal according to a plurality of channels of a corresponding frequency band, and outputs the resultant signal to the band selector 200-1. In detail, the first tunable filter 210 receives a signal of the first frequency band, the second tunable filter 220 receives a signal of the second frequency band, and the (N)th tunable filter 290 receives a signal of (N)th frequency band.

The first tunable filter 210 selectively filters the RF signal which is received through a plurality of channels of the first frequency band. Accordingly, an RF signal, after being selected and filtered by the first tunable filter 210, is output to the band selector 200-1.

Likewise, each of the second to (N)th tunable filters 220 to 290 selectively filters an RF signal received through a plurality of channels of corresponding frequency bands, and outputs the resultant RF signal to the band selector 200-1. As a result, the total (N) number of signals filtered by the first to (N)th tunable filters 210 to 290 are output to the band selector 200-1.

The band selector 200-1 receives the (N) number of signals from the (N) number of tunable filters 200, selects a desired band, and transmits a signal selected from the desired band to the ADC 140-1.

The process of sending out a filtered signal will now be explained below, particularly with reference to the operation of the tunable filter unit 100.

The DAC 140-2 receives a digital signal, converts it into an analog signal, and transmits the analog signal to the tunable filter unit 100.

The tunable filters 200 of the tunable filter unit 100 each receives the analog signal, filters the RF signal according to a plurality of channels of a corresponding frequency band, and outputs the resultant signal to the band selector 200-1. As a result, the tunable filter unit 100 outputs (N) number of signals from the (N) number of tunable filters 200 of the (N) number of frequency bands to the band selector 200-1.

The band selector 200-1 receives (N) number of signals from the tunable filters 200, selects a signal of a desired band, and sends the selected signal to the PA 130-2.

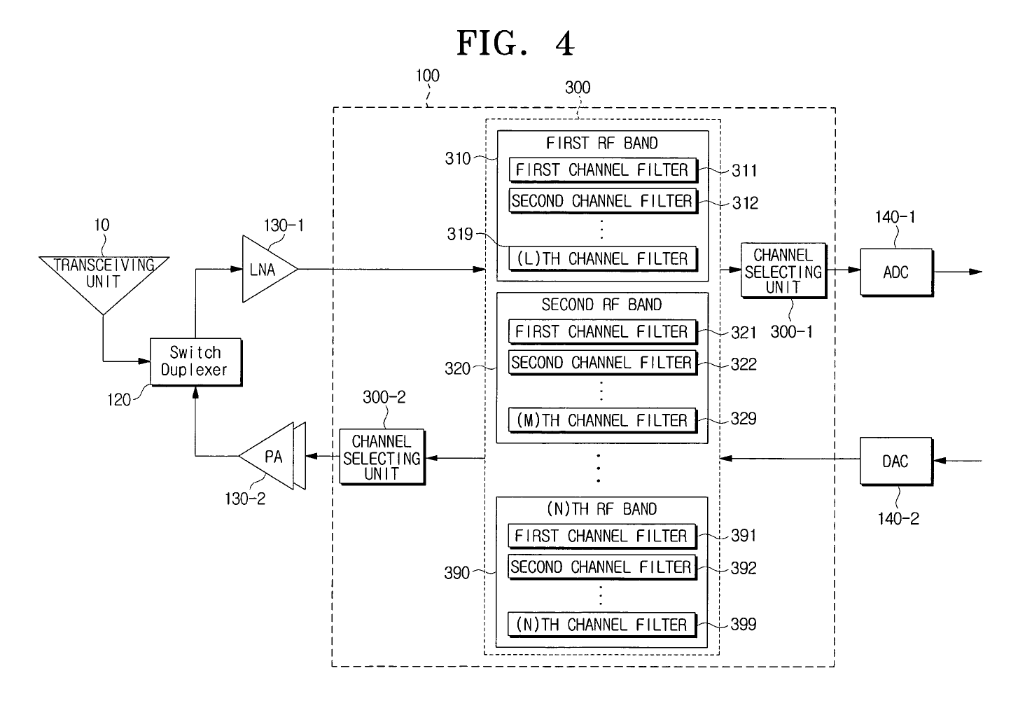

FIG. 4 is a block diagram of a transceiving apparatus according to a third exemplary embodiment of the present invention.

Referring back to FIG. 2, the transceiving apparatus according to the third exemplary embodiment of the present invention may include a transceiving unit 110, a switch duplexer 120, a low noise amplifier (LNA) 130-1, a power amplifier (PA) 130-2, a tunable filter unit 100, an analog-to-digital converter (ADC) 60-1, and a digital-to-analog converter (DAC).

The process of filtering a received signal will be explained in greater detail below, particularly with reference to the tunable filter unit 100, while other components, which have been explained above with reference to FIG. 2, will not be explained for the sake of brevity.

The tunable filter unit 100 may include channel filters 300 and channel selectors 300-1, 300-2.

The channel filters 300 may include a first, second, . . . , and (l)th channel filters 311 to 319 in a first RF band 310, a first, second, . . . , and (m)th channel filters 321 to 329 in a second RF band 320, and a first, second, . . . , and (n)th channel filters 391 to 399 in a (N)th RF band 390.

Each of the RF bands 310 to 390 may be classed according to a frequency band.

The number of channel filters in each of the RF bands 310 to 390 may be determined according to the number of channels of a corresponding RF band. For example, the first RF band 310 may include (l) number of channels, the second RF band 320 may include (m) number of channels, and the (N)th RF band 390 may include (n) number of channels.

The tunable filter unit 300 receives the signals from the LNA 130-1, and the channel filters in the tunable filter unit 300 filter the received signals and output resultant signals to the channel selector 300-1.

The channel selector 300-1 selects a desired channel from among the (l+m+n) number of signals filtered and output from the channel filters. As a result, signals are filtered by the channel filter of a channel selected by the channel selector 300-1, and output to the ADC 140-1.

The process of filtering an analog-converted signal will be explained below, particularly with reference to the operation of the tunable filter unit 100.

The tunable filter unit 300 receives signals from the DAC 140-2, and the channel filters in the tunable filter unit 300 filter the received signal and output the resultant signal to the channel selector 300-2.

The channel selector 300-2 selects a desired channel from among (l+m+n) number of signals filtered and output from the channel filters. As a result, signals are filtered by the channel filter of a channel selected by the channel selector 300-1, and output to the PA 130-2.

While a band or channel is selected upon completion of filtering by a tunable filter or channel filter, this is only one of examples. Alternatively, the band or channel selection may be performed concurrently with, or in advance of the filtering.

Furthermore, while the transceiving apparatus uses a tunable filter or a channel filter in both transmission and reception, one will understand that other alternatives are possible. For example, the tunable or channel filter may be used exclusively in transmission of a transmitting apparatus, or in reception of a receiving apparatus.

According to the exemplary embodiments of the present invention explained above, a multiband receiving apparatus using a tunable filter and a multiband transmitting apparatus using a tunable filter are provided, thereby simplifying a generally complicated RF transceiving system, reducing size of a transceiving apparatus, and also reducing time and cost for developing and designing the transceiving apparatus.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A multiband receiving apparatus, comprising:
a receiving unit for receiving radio frequency (RF) signals from a plurality of frequency bands, wherein each of the frequency band comprises a plurality of frequency channels; and
a tunable filter unit for filtering the RF signals received through the receiving unit according to the channel, and selecting and outputting an RF signal filtered at a predetermined channel.

2. The multiband receiving apparatus of claim 1, wherein the tunable filter unit comprises:
a plurality of tunable filters provided for each of the frequency bands; and
a band selecting unit for selecting a predetermined frequency band from the plurality of frequency bands, and outputting the filtered RF signal.

3. The multiband receiving apparatus of claim 2, wherein the tunable filters each filters an RF signal received through the receiving unit from each of the frequency bands, and selects and outputs the filtered RF signal of a predetermined channel.

4. The multiband receiving apparatus of claim 1, wherein the tunable filter unit comprises:
channel filters provided for each of the plurality of frequency channels; and
a channel selecting unit for selecting a predetermined frequency channel so that an RF signal being filtered by the channel filter of the predetermined frequency band is output.

5. A multiband transmitting apparatus, comprising:
a tunable filter unit for filtering radio frequency (RF) signals of a plurality of frequency bands according to the channel, and selecting and outputting an RF signal filtered at a predetermined channel, wherein the frequency bands each comprise a plurality of frequency channels; and
a transmitting unit for transmitting the signal output from the tunable filter unit.

6. The multiband transmitting apparatus of claim 5, wherein the tunable filter unit comprises:
a plurality of tunable filters provided for each of the frequency bands; and
a band selecting unit for selecting a predetermined frequency band from the plurality of frequency bands, and outputting the filtered RF signal.

7. The multiband transmitting apparatus of claim 6, wherein the tunable filters each filters an RF signal received through the receiving unit from each of the frequency bands, and selects and outputs the filtered RF signal of a predetermined channel.

8. The multiband transmitting apparatus of claim 5, wherein the tunable filter unit comprises:
channel filters provided for each of the plurality of frequency channels; and
a channel selecting unit for selecting a predetermined frequency channel so that an RF signal being filtered by the channel filter of the predetermined frequency band is output.
